(19) United States
(12) Patent Application Publication
(10) Pub. No.: US 2011/0131333 A1
(43) Pub. Date: Jun. 2, 2011

(54) DEVICE, SYSTEM AND METHOD FOR REMOTE IDENTIFICATION, MANAGEMENT AND CONTROL OF SEPARATE WIRELESS DEVICES BY LINKED COMMUNICATION AWARENESS AND SERVICE LOCATION

(75) Inventors: Andrew W. Buffmire, Salt Lake City, UT (US); Peter van der Gracht, Vancouver (CA); Ruskin Taylor Lhamon, Seattle, WA (US); William Patrick Cortes, Bellevue, WA (US)

(73) Assignee: SIGNALSET, INC., Salt Lake City, UT (US)

(21) Appl. No.: 12/915,255

(22) Filed: Oct. 29, 2010

Related U.S. Application Data
(60) Provisional application No. 61/256,840, filed on Oct. 30, 2009.

(51) Int. Cl. G06F 15/16

(52) U.S. Cl. 709/227

(57) ABSTRACT

Systems and methods are operable to limit use of a Controlled Wireless Device within a controlled environment. An exemplary embodiment establishes a first wireless communication link between a Controlled Wireless Device and a Linked Context Aware Communication and Control Device (LCACCD) Platform, detects proximity of the Controlled Wireless Device to the controlled environment, communicates a control signal from the LCACCD Platform to the Controlled Wireless Device when the Controlled Wireless Device is within the controlled environment, and controls communications of the Controlled Wireless Device based upon the communicated control signal, wherein the Controlled Wireless Device is communicating over a second wireless link established with a wireless carrier network.

### PRIORITY CLAIM

This patent application claims priority from copending U.S. Provisional Patent Application Ser. No. 61/256,840, filed Oct. 30, 2009, and entitled, “Device, System and Method For Remote Identification, Management And Control Of Separate Wireless Devices By Linked Communication Awareness And Service Location,” the contents of which are hereby incorporated by reference in its entirety.

### BACKGROUND OF THE INVENTION

With the expanded use of mobile wireless communication devices for voice, data, email and short message services (SMS), significant concerns have arisen with respect to the potential adverse and other impacts that can arise from the use of wireless devices during user activities in various static and mobile environments. These concerns include, for example, distraction and safety concerns in connection with the use of handheld wireless devices for voice, data, email and/or SMS communications while driving. In response to these concerns, several states have in recent years even banned the use of handheld voice communication devices and text messaging in moving vehicles. In addition, insurers have modified premiums to reflect potential increased liability from such usage in moving vehicles and in other high risk environments.

Because of potential significant legal and financial exposure from the increased usage of wireless devices in moving vehicles, companies and enterprises have sought to mitigate these risks by prohibiting usage of wireless devices by their agents or employees in moving vehicles and/or limiting the activities that can take place on those devices when a vehicle is in operation or in a high risk environment. Such prohibitions have had limited effectiveness in significant part because such employees and/or agents have their own wireless devices and cell phones that can be used personally in such high risk environments and activities effectively beyond the control of the Company or enterprise.

Current prohibitions and limitations on agent and employee usage are not effective due to the potential of misbehavior of the agent or employee. Accordingly. substantial operational, financial and legal risk remains for companies and enterprises from the uncontrolled and improper usage of employee and/or agent controlled wireless devices in moving vehicles and in other high risk environments for voice, voice mail, data, email and SMS communications.

What is needed is a device, method and system to mitigate the risk of harm that could occur when the user of the mobile wireless communication device is distracted from a particular task while using their mobile wireless communication device.

### SUMMARY OF THE INVENTION

Systems and methods are operable to limit use of a Controlled Wireless Device within a controlled environment. An exemplary embodiment establishes a first wireless communication link between a Controlled Wireless Device and a Linked Context Aware Communication and Control Device (LCACCD) Platform, detects proximity of the Controlled Wireless Device to the controlled environment, communicates a control signal from the LCACCD Platform to the Controlled Wireless Device when the Controlled Wireless Device is within the controlled environment, and controls communications of the Controlled Wireless Device based upon the communicated control signal, wherein the Controlled Wireless Device is communicating over a second wireless link established with a wireless carrier network

An exemplary embodiment of the present invention identifies the existence and activation status of one or more controlled wireless devices. Examples of a controlled wireless device include, but are not limited to, a cell-phone, computer data terminal, smartphone or other wireless device (the “Controlled Wireless Device”). Typically, the Controlled Wireless Device is located in a company or enterprise controlled environment (the “Controlled Environment”) where it is desirable to control and/or prohibit use of the Controlled Wireless Device. Embodiments determine the activation and operating status of such controlled wireless devices (the “Device Activities”). In response to detecting operation of a controlled wireless device during an operation in a “Controlled Environment”, embodiments deploy and execute direct wireless commands and/or carrier network based commands to control and/or limit the usage of the Controlled Wireless Device when it is in the Controlled Environment. That is, when the Controlled Wireless Device is active and engaged, or is potentially engaged, embodiments control and/or limit operation of the Controlled Wireless Device to mitigate potentially risky communication activities during such Device Activities.

### DETAILED DESCRIPTION OF THE PREFERRED EMBODIMENT

Embodiments of a Linked Context Aware Communication and Control Device (LCACCD) Platform include a device, system and/or method for identifying the existence and location of a Controlled Wireless Device when in, and/or in proximity to, the Controlled Environment. Accordingly, Device Activities while in the Controlled Environment are controlled and/or limited.

The Controlled Environment is a predefined geographic region in which control of the Controlled Wireless Device is desirable. For example, a work or task area associated with a particular commercial activity may be defined as the Controlled Environment. To illustrate, it may be desirable to control operation of the Controlled Wireless Device when a train conductor is operating a train at a train station or the like. Thus, the Controlled Environment may be some predefined geographic region relating to the train station.

Alternatively, or additionally, the Controlled Environment may be a predefined operating environment. For example, operation of a vehicle, or the vehicle itself, may be defined as the Controlled Environment. To illustrate, it may be desirable to control operation of the Controlled Wireless Device when the driver of an automobile is operating the automobile. Thus, the Controlled Environment may be defined to occur when the vehicle is turned on, is moving, or the like.

Embodiments of the LCACCD Platform are communicatively integrated with a direct wireless enabled and/or wireless carrier network enabled link and command system to limit and control the operation of the Controlled Wireless Device when it is in, or within proximity to, the Controlled Environment.

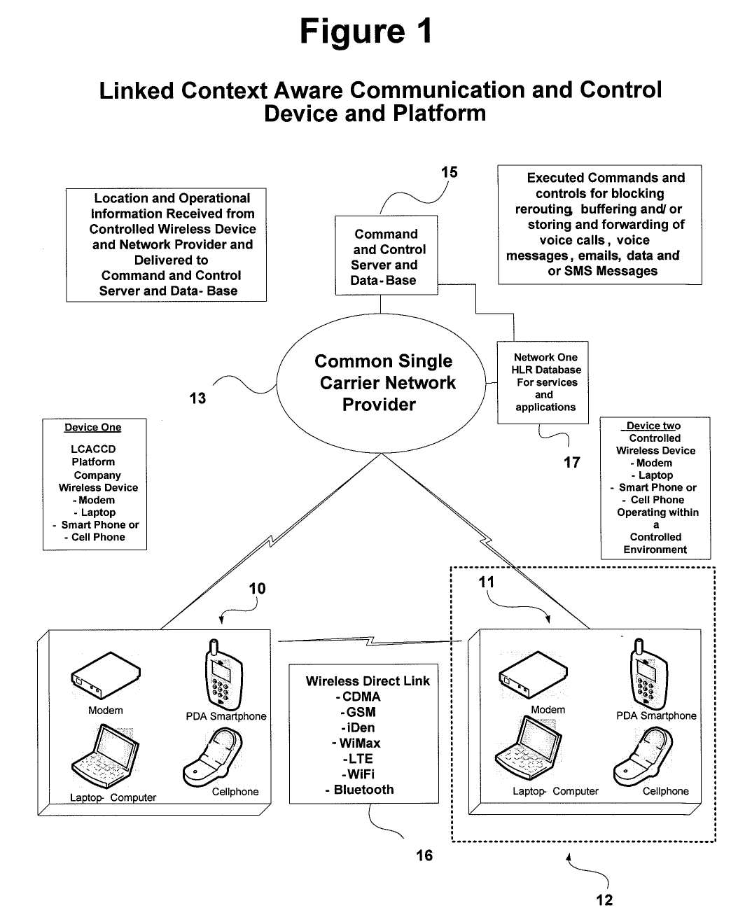

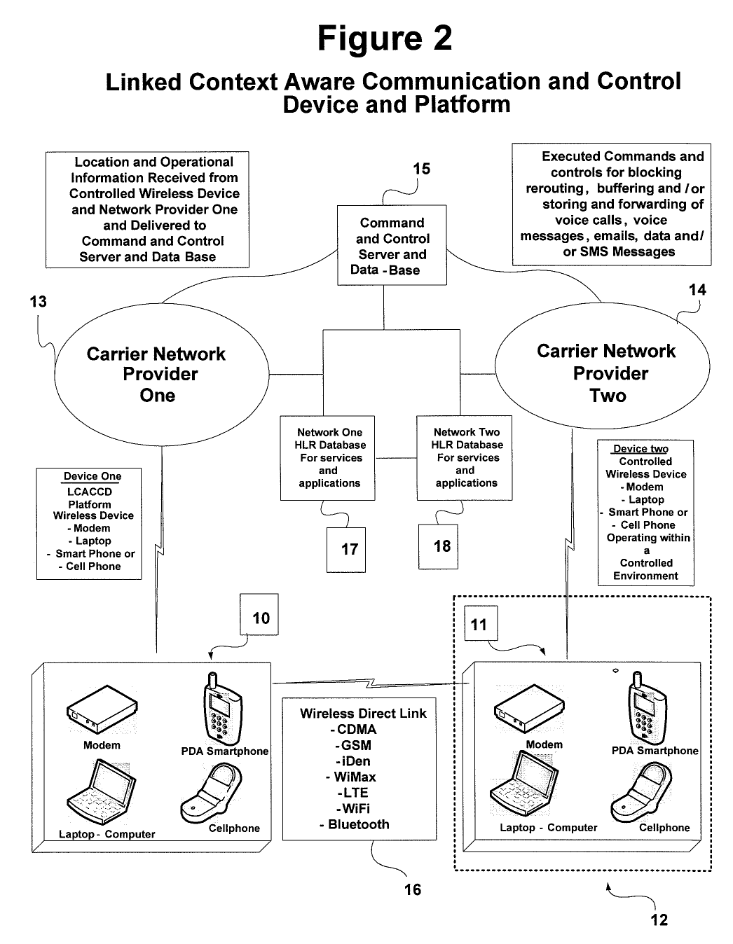

In order to determine the presence of the Controlled Wireless Device, and/or identify any ongoing Device Activities by the Controlled Wireless Device while in or in proximity to the Controlled Environment, a wireless communication link may be established between the Controlled Wireless Device and the carrier network on which it operates (the “Carrier Network”) at least when the Controlled Wireless Device. Additionally, or alternatively, a wireless communication link may be established directly with a LCACCD Platform wireless device located in, in proximity to, and/or near to, the Controlled Environment. FIGS. 1 and 2, described in greater detail below, show various wireless links and wireless air interface technologies and methods by which this wireless connection may be realized.

Exemplary non-limiting wireless communication technologies include one or more of the following (the “Airlink Technologies”):

1. Wide area network communications through a Carrier Network using one or more of the following air interface (wireless) technologies and/or other similar or related air interface technologies:
a. Code Division Multiple Access (CDMA)
b. CDMA Rev A
c. Global System for Wireless (GSM)
d. High Speed Data Packet Access (HSDPA)
e. Global Packet Radio Service (GPRS)
f. Orthogonal Frequency Division Multiplexing (OFDM)
g. WiMax
h. Long Term Evolution (LTE)

2. Private Wide Area Networks using one or more of the following technologies and/or similar or related air interface technologies
a. Private Mobile Radio
b. Trunked Radio Systems

3. Paging and MobiTex Networks

4. Citizens Band (CB) Radio

5. Direct wireless connectivity between the LCACCD Platform Wireless

Device and the Controlled Wireless Device using one or more of the following air interface technologies and/or other similar or related air interface technologies:
a. WiFi
b. WiMax
c. Code Division Multiple Access (CDMA)
d. CDMA Rev A
e. Global System for Wireless (GSM)
f. High Speed Data Packet Access (HSDPA)
g. Global Packet Radio Service (GPRS)
h. Orthogonal Frequency Division Multiplexing (OFDM)
i. WiMax
j. Long Term Evolution (LTE)
   Any suitable wireless communication technology may be used in the various embodiments to establish the wireless communication links.

Upon the establishment of connectivity with the Controlled Wireless Device, either directly with the LCACCD Platform Wireless Device or through the Carrier Network, the determination of proximity of a Controlled Wireless Device, and optionally an occurrence of Device Activities, within the Controlled Environment may be determined by one or more of the following:

1. The receipt, review and analysis of data generated from Global Position Satellite (GPS) devices in one or both of the Controlled Wireless Device and/or the LCACCD Platform.

2. The receipt, review and analysis of data generated from accelerometers in one or both of the Controlled Wireless Device and the LCACCD Platform.

3. The receipt, review and analysis of voice pattern measurement and recognition to determine location and the operating relationship between the Controlled Wireless Device and the LCACCD Platform.

4. The receipt, review and analysis of audio pattern measurement and recognition to determine location and the operating relationship between the Controlled Wireless Device and the LCACCD Platform.

5. The receipt, review and analysis of relative location and operating relationship between the Controlled Wireless Device and the LCACCD Platform, and whether or not the Controlled Wireless Device is in the LCACCD Platform using network reporting and control information as follows:
a. Radio tower hand-off, location and timing for the Controlled Wireless Device.
b. Carrier Network registration messages for the Controlled Wireless Device.
c. Carrier Network reported GPS and movement information including:
   i. Location
   ii. Time
   iii. Speed
   iv. Direction of travel
   v. Relative altitude
   vi. Any or all combinations of the foregoing

6. Any combination of the foregoing.

Once it is determined that the Controlled Wireless Device is in the Controlled Environment and engaging in, or about to engage in, high risk or prohibited Device Activities, the following commands and/or instructions in a control signal can be issued to avoid the high risk and/or prohibited Device Activities by the Controlled Wireless Device:

1. The blocking, rerouting, buffering and/or storing and forwarding of voice calls, voice messages, emails, data and/or SMS messages otherwise deliverable to the Controlled Wireless Device and/or the LCACCD Platform.

2. The delivery of voice calls, voice messages, emails, data and/or SMS messages based upon a change in location or status of the Controlled Wireless Device and/or the LCACCD Platform.

3. The delivery of alerts so that the status of the Controlled Wireless Device and/or the LCACCD Platform can be changed to allow for receipt, acknowledgement and/or review of voice calls, voice messages, emails, data transmissions and/or SMS messages that have been previously blocked, rerouted, buffered and/or stored for forwarding. (For example, but not limited to, the alert may indicate the exiting of the Controlled Wireless Device 11 from the controlled environment so that uncontrolled communications by the Controlled Wireless Device are allowed over the wireless carrier network).

For example, but not limited to, an incoming voice call to the Controlled Wireless Device may be blocked when the Controlled Wireless Device is within the controlled environment. The received voice call may be redirected to a voice mail accessibly by the Controlled Wireless Device. In one embodiment, the availability of the voice mail is indicated to the Controlled Wireless Device when the Controlled Wireless Device is no longer within the controlled environment. The Controlled Wireless Device may then indicate the availability of the voice mail to its user. In another embodiment, availability of the voice mail is indicated by the Controlled Wireless Device to the user when the voice mail is received, but only allow user access to the voice mail is not provided until the Controlled Wireless Device is no longer within the controlled environment.

FIG. 1 is an overview of an embodiment of a Linked Context Aware Communication and Control Device LCACCD Platform 10 system in communication with the same network provider 13 for both the LCACCD Platform 10 and an exemplary Controlled Wireless Device 11. The Controlled Wireless Device 11 is located within the Controlled Environment 12. The LCACCD Platform 10 may optionally be connected wirelessly through the common Carrier Network 13.

Alternatively, or additionally, connectivity to the Company Command and Control Server Database 15 may be established with the Controlled Wireless Device and/or the LCACCD Platform 10 via the Carrier Network 13. Further instructions as necessary for control of actions by, or limitations on, the Controlled Wireless Device are in part, or in whole, furthermore controlled or directed by the Common Single Carrier Network Provider operational data-base or Home Location Register (HLR) 17.

Alternatively, or additionally, connectivity may be established between the Controlled Wireless Device 11 and the LCACCD Platform 10 via a direct wireless link 16. Thus, the LCACCD Platform can detect the Controlled Wireless Device and/or directly control the Controlled Wireless Device. Further, the LCACCD Platform may optionally be physically located to or in proximity to the Controlled Environment 12, or may be remote from the Controlled Environment 12.

FIG. 2 is an overview of an alternative embodiment of a Linked Context Aware Communication and Control Device and Platform system in communication with the different carrier network providers 13, 14 for both the LCACCD Platform 10 and the Controlled Wireless Device 11 when the Controlled Wireless Device 11 is located within the Controlled Environment 12.

The LCACCD Platform 10 physical location and operational relationship with the Controlled Wireless Device 11 may be connected wirelessly through Carrier Network One 13 and Carrier Network Two 14. Alternatively, or additionally, connectivity may be provided to the Command and Control Server Database 15, Alternatively, or additionally, connectivity may be established between the Controlled Wireless Device 11 and the LCACCD Platform 10 through a direct wireless link 16.

Further instructions as necessary for actions by, or limitations on, the Controlled Wireless Device 11 are, in part or in whole, furthermore controlled or directed by the Network One operational data-base or Home Location Register (HLR) 17. Further instructions as necessary for actions by or limitations on the Controlled Wireless Device 11 are in part or in whole furthermore controlled or directed by the Network Two operational data-base or Home Location Register (HLR) 18.

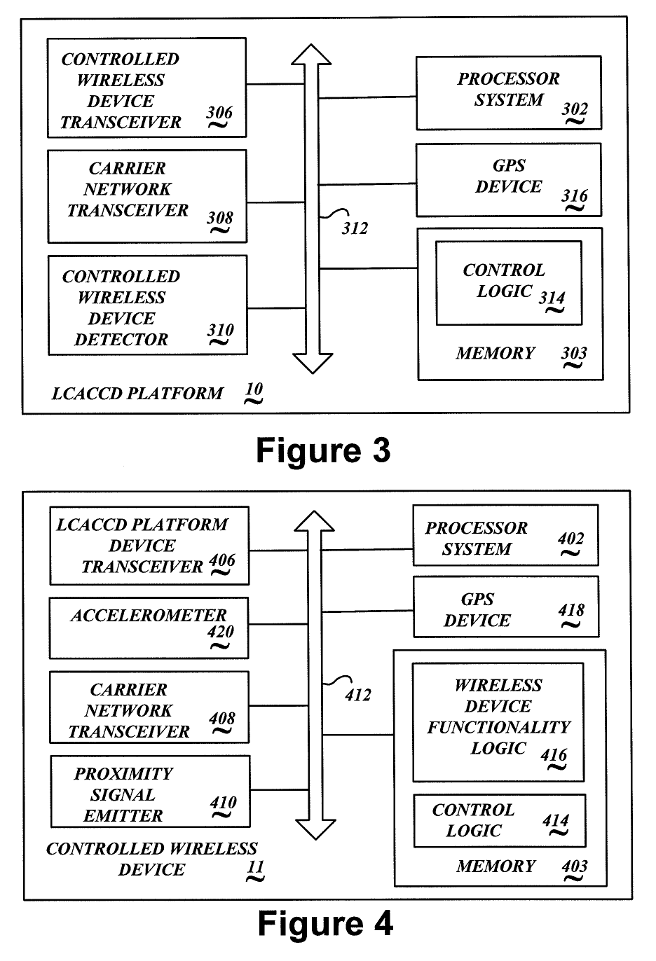

FIG. 3 is an embodiment of an exemplary LCACCD Platform 10. The exemplary LCACCD Platform 10 includes a processor system 302, a memory 304, a Controlled Wireless Device transceiver 306, a Carrier Network transceiver 308, an optional Controlled Wireless Device detector 310, and an optional GPS device 316. The above-described components are communicatively coupled together via communication bus 312. Control logic 314 resides in memory 304. In alternative embodiments of the LCACCD Platform 10, the above-described components may be communicatively coupled to each other in a different manner. For example, one or more of the above-described components may be directly coupled to the processor system 302, or may be coupled to the processor system 302 via intermediary components (not shown). Further, additional components (not shown) may be included in alternative embodiments of the LCACCD Platform 10.

The Controlled Wireless Device transceiver 306 supports communications with the Controlled Wireless Device 11. The Carrier Network transceiver 308 supports communications with the Carrier Networks. In the exemplary embodiment, the transceivers 306, 308 are illustrated as separate components so as to support communications using different media types and/or formats. Alternatively, the transceivers 306, 308 may be a single transceiver if compatible communication technologies are employed. It is appreciated that any suitable transceiver device or system may be used, and that the transceivers 306, 308 may have a variety of components therein which are not described or illustrated herein for brevity. For example, but not limited to, the transceivers 306, 308 may include as components a receiver and a transmitter device or system. Further, such components themselves may be separate devices or systems. Further, transceivers 306, 308 may use any suitable wireless communication medium. For example, a wireless signal may employ a radio frequency (RF), an infrared, a visible light, an ultraviolet, or a microwave frequency. Accordingly, the transceivers 306, 308 are configured to transmit and/or receive any suitable communication communication media. Alternatively, or additionally, the transceivers 306, 308 may be configured to couple to a wire-based system and receive communications over a wire-based system, such as, but not limited to, a cable system or the Internet.

The optional Controlled Wireless Device detector 310 is configured to detect proximity of the Controlled Wireless Device 11 to the LCACCD Platform 10 and/or proximity to the Controlled Environment 12. For example, but not limited to, the Controlled Wireless Device 11 may include a suitable emitter that emits a detectable signal. When the Controlled Wireless Device detector 310 detects the signal emitted by the Controlled Wireless Device 11, then suitable control actions can be initiated.

Control logic 314 is retrieved and executed by the processor system 302 to enable control functionality over the Controlled Wireless Device 11 as described herein. The processor system 302 may be any suitable processor or device. The processor system 302 may be a commercially available processor. In other embodiments, the processor system 302 may be a specially designed and fabricated processor, or may be part of a multi-purpose processing system.

FIG. 4 is an embodiment of an exemplary Controlled Wireless Device 11. The exemplary Controlled Wireless Device 11 includes a processor system 402, a memory 404, a LCACCD Platform Device transceiver 406, a Carrier Network transceiver 408, an optional proximity signal emitter 410, an optional GPS device 418, and an optional accelerometer 420. The above-described components are communicatively coupled together via communication bus 412. The control logic 414 and the wireless device functionality logic 416 reside in memory 304. In alternative embodiments of the Controlled Wireless Device 11, the above-described components may be communicatively coupled to each other in a different manner. For example, one or more of the above-described components may be directly coupled to the processor system 402, or may be coupled to the processor system 402 via intermediary components (not shown). Further, additional components (not shown) are included in alternative embodiments of the Controlled Wireless Device 11.

The LCACCD Platform Device transceiver 406 supports communications with the LCACCD Platform 10. The Carrier Network transceiver 408 supports communications with the Carrier Networks. In the exemplary embodiment, the transceivers 406, 408 are illustrated as separate components so as to support communications using different media types. Alternatively, the transceivers 406, 408 may be a single transceiver if compatible communication technologies are employed. It is appreciated that any suitable transceiver device or system may be used, and that the transceivers 306, 308 may have a variety of components therein which are not described or illustrated herein for brevity. For example, but not limited to, the transceivers 406, 408 may include as components a receiver and a transmitter device or system. Further, such components themselves may be separate devices or systems. Further, transceivers 406, 408 may use any suitable wireless communication medium. For example, a wireless signal may employ a radio frequency (RF), an infrared, a visible light, an ultraviolet, or a microwave frequency. Accordingly, the transceivers 406, 408 are configured to transmit and/or receive any suitable communication communication media. Alternatively, or additionally, the transceivers 406, 408 may be configured to couple to a wire-based system and receive communications over a wire-based system, such as, but not limited to, a cable system or the Internet.

The optional proximity signal emitter 410 is configured to emit a detectable proximity signal that indicates proximity of the Controlled Wireless Device 11 to the LCACCD Platform 10 and/or proximity to the Controlled Environment 12. The emitted detectable proximity signal is emitted with a predefined signal power that is configured to be detectable at a predefined range. When the controlled wireless device detector 310 is within the predefined range, the detectable proximity signal is detectable by the controlled wireless device detector 310. When the controlled wireless device detector 310 is beyond the predefined range, the detectable proximity signal is not detectable by the controlled wireless device detector 310. For example, but not limited to, the proximity signal emitter 410 may emit an infrared signal, a coded wireless signal, a wireless signal defined by at least one predefined frequency, or the like. When the above-described Controlled Wireless Device detector 310 detects the signal emitted by the proximity signal emitter 410, then suitable control actions can be initiated.

Control logic 414 is retrieved and executed by the processor system 402 to enable control functionality by the Controlled Wireless Device 11 as described herein. For example, the control logic 414 may inhibit or otherwise control operation of the Controlled Wireless Device 11. In some embodiments, control logic 414 is omitted, and control functionality is implemented in other devices and/or systems to control operation of the Controlled Wireless Device 11.

The wireless device functionality logic 416 is retrieved and executed by the processor system 402, or another suitable processor system, to enable the desired functionality of the Controlled Wireless Device 11. For example, if the Controlled Wireless Device 11 is a mobile phone, then the wireless device functionality logic 416 would enable the Controlled Wireless Device 11 to operate as intended.

For convenience, the control logic 414 and the wireless device functionality logic 416 were illustrated and described as separate logic. In some embodiments, the control logic 414 and the wireless device functionality logic 416 may be integrated together, and/or integrated with other logic.

The processor system 402 may be any suitable processor or device. The processor system 402 may be a commercially available processor. In other embodiments, the processor system 402 may be a specially designed and fabricated processor, or may be part of a multi-purpose processing system.

The GPS devices 316 and 418 are configured to detect and/or determine the location of the LCACCD Platform 10 and the Controlled Wireless Device 11, respectively. The determined location information may be used to determine if the Controlled Wireless Device is within the controlled environment, in proximity to the controlled environment, and/or in proximity to the LCACCD Platform 10. For example, but not limited to, if the Controlled Wireless Device 11 is within the controlled environment, based upon location information determined by the GPS device 316 and/or the GPS device 418, then the LCACCD Platform 11 may issue control instructions to the Controlled Wireless Device 11. As another example, if the Controlled Wireless Device 11 is within some predefined distance of the LCACCD Platform 10, a wireless communication link may be established between the Controlled Wireless Device 11 and the LCACCD Platform 10, and/or the LCACCD Platform 11 may issue control instructions to the Controlled Wireless Device 11.

The optional accelerometer 420 is configured to detect movement of the Controlled Wireless Device 11. For example, the Controlled Wireless Device 11 may be in a vehicle. During operation of the vehicle, determined based upon detection of movement by the accelerometer 420, the LCACCD Platform 11 may issue control instructions to the Controlled Wireless Device 11.

In summary, what is disclosed are embodiments for the identification and context aware identification of the relationship and operational status of a LCACCD Platform 10 and an Controlled Wireless Device 11. Accordingly, when the Controlled Wireless Device 11 is within, or in proximity to, a Controlled Environment 12, embodiments are configured to control operation of the Controlled Wireless Device 11. Such control actions include, but are not limited to, the blocking, rerouting, buffering and/or storing and forwarding of voice calls, voice messages, emails, data and/or SMS messages otherwise deliverable to the Controlled Wireless Device 11.

It is appreciated that embodiments of the LCACCD Platform 10 may be configured to control a plurality of Controlled Wireless Devices 11. For example, if the Controlled Environment 12 is a vehicle, any number of Controlled Wireless Devices 11 that are anticipated to be within the vehicle could be configured to be controlled by embodiments of the LCACCD Platform 10. Further, embodiments of the LCACCD Platform 10 may be configured to concurrently control multiple Controlled Wireless Devices 11.

The scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for the controlling wireless devices proximate to a controlled environment, comprising:
a Linked Context Aware Communication and Control Device (LCACCD) Platform; and
a Controlled Wireless Device configured to establish a first wireless link to the LCACCD Platform and configured to establish a second wireless link to a wireless carrier network,
wherein the LCACCD Platform is configured to detect proximity of the Controlled Wireless Device to the controlled environment, and
wherein the LCACCD Platform is configured to control at least one operation of the Controlled Wireless Device when the Controlled Wireless Device is at least within the controlled environment.

2. The system of claim 1, wherein LCACCD Platform and the Controlled Wireless Device are configured to establish the first wireless link at least when the Controlled Wireless Device is within proximity of the controlled environment.

3. The system of claim 1, wherein LCACCD Platform and the Controlled Wireless Device are configured to establish the first wireless link over the wireless carrier network.

4. The system of claim 1, wherein the carrier network is a first carrier network, and wherein LCACCD Platform and the Controlled Wireless Device are configured to establish the first wireless link over a second carrier network, and wherein the second carrier network is different from the first carrier network.

5. The system of claim 1, further comprising:
a first transceiver residing in the LCACCD Platform; and
a second transceiver residing in the Controlled Wireless Device,
wherein the first wireless link is established directly between the second transceiver of the Controlled Wireless Device and the first transceiver of the LCACCD Platform.

6. The system of claim 1, further comprising:
a proximity signal detector residing in the Controlled Wireless Device and configured to emit a detectable proximity signal with a predefined signal power that is configured to be detectable at a predefined range; and
a controlled wireless device detector residing in the LCACCD Platform and configured to detect the detectable proximity signal when the Controlled Wireless Device is within the predefined range to the LCACCD Platform,
wherein the LCACCD Platform is configured to control at least one operation of the Controlled Wireless Device when the detectable proximity signal is detected by the LCACCD Platform.

7. The system of claim 1, further comprising:
a global positioning system (GPS) device residing in the Controlled Wireless Device and configured to determine a location of the Controlled Wireless Device,
wherein the LCACCD Platform is configured to control at least one operation of the Controlled Wireless Device when the GPS device determined location of the Controlled Wireless Device is within the controlled environment.

8. The system of claim 7, wherein the GPS device residing in the Controlled Wireless Device is a first GPS device, and further comprising:
a second GPS device residing in the LCACCD Platform and configured to determine a location of the LCACCD Platform,
wherein the LCACCD Platform is configured to control at least one operation of the Controlled Wireless Device when the GPS device determined location of the Controlled Wireless Device is within the a pre-determined distance of the GPS device determined location of the LCACCD Platform.

9. The system of claim 1, further comprising:
an accelerometer residing in the Controlled Wireless Device and configured to determine a movement of the Controlled Wireless Device,
wherein the LCACCD Platform is configured to control at least one operation of the Controlled Wireless Device when movement of the Controlled Wireless Device is detected.

10. A method of controlling wireless devices proximate to a controlled environment, comprising:
establishing a first wireless communication link between a Controlled Wireless Device and a Linked Context Aware Communication and Control Device (LCACCD) Platform;
detecting proximity of the Controlled Wireless Device to the controlled environment;
communicating a control signal from the LCACCD Platform to the Controlled Wireless Device when the Controlled Wireless Device is within the controlled environment; and
controlling communications of the Controlled Wireless Device based upon the communicated control signal, wherein the Controlled Wireless Device is communicating over a second wireless link established with a wireless carrier network.

11. The method of claim 10, wherein the first wireless link is established at least when the Controlled Wireless Device is within proximity of the controlled environment.

12. The method of claim 10, wherein establishing the first wireless link comprises:
establishing the first wireless link between the Controlled Wireless Device and the LCACCD Platform over the wireless carrier network.

13. The method of claim 10, wherein the carrier network is a first carrier network, and wherein establishing the first wireless link comprises:
establishing the first wireless link between the Controlled Wireless Device and the LCACCD Platform over a second carrier network, wherein the second carrier network is different from the first carrier network.

14. The method of claim 10, wherein the control signal comprises at least one control signal selected from a group consisting of a control signal configured to block communications by the Controlled Wireless Device over the wireless carrier network, a control signal configured to reroute communications to the Controlled Wireless Device over the wireless carrier network, a control signal configured to buffer communications to the Controlled Wireless Device, a control signal configured to store and forward voice calls, voice messages, emails, data or SMS messages to the Controlled Wireless Device, a control signal configured to alert a status of the Controlled Wireless Device, and a control signal configured to allow uncontrolled communications by the Controlled Wireless Device over the wireless carrier network.

15. The method of claim 10, further comprising:
sensing a movement of the Controlled Wireless Device using an accelerometer,
wherein the control signal is communicated from the LCACCD Platform to the Controlled Wireless Device when the Controlled Wireless Device is moving.

16. The method of claim 10, wherein the Controlled Wireless Device resides in a vehicle, and wherein the vehicle defines the controlled environment.

17. The method of claim 10, wherein controlling communications of the Controlled Wireless Device comprises:
blocking a voice call to the Controlled Wireless Device;
redirecting the received voice call to voice mail; and
indicating the availability of the voice mail to the Controlled Wireless Device.

18. The method of claim 17, wherein the availability of the voice mail is indicated after the Controlled Wireless Device is no longer within the controlled environment.

19. The method of claim 10, wherein detecting proximity of the Controlled Wireless Device to the controlled environment comprises:
determining a location of the Controlled Wireless Device using a global positioning system (GPS) device residing in the Controlled Wireless Device,
wherein the control signal is communicated from the LCACCD Platform to the Controlled Wireless Device when is within the controlled environment based upon the location determined by the GPS device.

20. The method of claim 19, wherein the GPS device residing in the Controlled Wireless Device is a first GPS device, and wherein detecting proximity of the Controlled Wireless Device to the controlled environment further comprises:
determining a location of the LCACCD Platform using a second global GPS device residing in the LCACCD Platform,
wherein the control signal is communicated from the LCACCD Platform to the Controlled Wireless Device when the determined location of the Controlled Wireless Device is within the a pre-determined distance of the determined location of the LCACCD Platform.
